(19) United States
(12) Patent Application Publication
(10) Pub. No.: US 2016/0307432 A1
(43) Pub. Date: Oct. 20, 2016

(54) Automative Child Seat Sensing System

(71) Applicant: Norma J. Downs, Coxs Creek, KY (US)

(72) Inventor: Norma J. Downs, Coxs Creek, KY (US)

(21) Appl. No.: 14/691,478

(22) Filed: Apr. 20, 2015

(51) Int. Cl. G08B 21/24; G08B 21/22; G08B 7/06

(52) U.S. Cl. CPC G08B 21/24; G08B 7/06; G08B 21/22

(57) ABSTRACT

The present invention provides an alarm system for vehicles to alert distracted parents, guardians, and custodians that their child is present in the locked car. The alarm system has sensors, speakers, and display units. The sensors are weight sensors, which detect the weight of the baby. Sensors are fitted in the back seat of the vehicle. Whenever the child is left in the locked car, the same time sensors will start sending signals to the alarm system. The alarm system has two features for alerting caretakers. First, it alerts caretaker by saying the words “please check back seat.” Secondly, it shows signs of car seat in the side view mirror, dash display, and on the steering column. All the parts of the alarm system are connected with the help of wires with each other.

### ICROSS REFERENCE TO RELATED APPLICATIONS

Not applicable

### (C) FEDERALLY SPONSORED RESEARCH AND DEVELOPMENT

Not applicable.

### (D) MICROFICHE

Not applicable

### BACKGROUND OF THE INVENTION

(1) Field of the Invention

The present invention generally relates to alarm systems for vehicles. More specifically, the present invention relates to vehicle alarm systems that alert distracted parents and guardians about the presence of young children in the back seat of the vehicle.

(2) Background of the Invention

Infant alarm systems for automobiles are desirable for reminding drivers that a child has been left in an infant seat after the driver has exited the vehicle. Each year, many children fall victim to errors of forgetfulness on behalf of their guardian when they are left in a vehicle unattended.

This device is an attempt to prevent the injuries and deaths that have occurred when children are left locked in car seat restraints in extreme heat or extreme cold.

Every year, there are news stories of the deaths of children and infants that had been left unattended in cars. These children and infants expire from the extreme heat or cold that builds up in a vehicle when the children are left in a vehicle without air conditioning for ventilation. Although the legislature of Kentucky has attempted to address this problem by making it illegal to leave a child unattended in a vehicle, this does not prevent these tragedies. Children are still left by busy, distracted, and sometimes neglectful parents and caregivers. There needs to be some way of warning that a child has been left locked in a child car seat restraint. Some ideas in the past, although effective, were elaborate and would have been difficult to implement.

It's already known in the prior art that there is a warning system for detecting the presence of a child in an infant seat when a child has been left in an infant seat and a vehicle has been turned off. The apparatus includes an occupant detection mechanism for detecting the presence of an occupant within an infant seat that is located within a vehicle, an ignition detection mechanism for detecting the state of the vehicle's ignition system, a control unit for generating an alarm signal when the occupant detection mechanism detects the presence of an occupant within the infant seat and the ignition detection mechanism detects that the vehicle's ignition system has been turned from an “on” state to an “off” state, and alarm units for generating an alarm in response to the alarm signal. The components of the apparatus can be located within the infant seat, within the vehicle, or combined within the infant seat and the vehicle.

There is a prior art which discloses a child alert system for automobiles. In one form, it is an alarm system for detecting the presence of a person locked in a parked automobile. The alarm system includes a motion detector and a temperature detecting element coupled to a NOR gate. The motion detector transmits a low signal to the NOR gate once it detects motion within the interior of the automobile. The temperature detecting element transmits a low signal to the NOR gate if the temperature in the automobile exceeds a pre-determined extreme temperature. The NOR gate, upon receiving low signals from both the temperature detecting element and the motion detector, transmits an alarm signal.

There a prior art which discloses a seat-operated switch and warning system. The seat operated switch and warning system includes an air cushion, an air tube leading from the air cushion to an air pressure switch, an electronic circuit to activate devices when a reduction in air pressure is sensed, a digital recordable message device, a radio frequency transmitting device, a housing to contain the pressure switch, digital message device and transmitting device, a is matching radio frequency receiving device, and a portable housing to contain said receiving device said housing also containing an audio transducer that creates an audible warning sound activated by said receiving device. In a preferred embodiment, when a person sits on said air cushion, the pressure caused by the weight of the person causes said air pressure switch not to activate, but when said person exits off of said air cushion said air pressure switch causes said recorded message to play and causes said transmitter to send a signal to said receiver causing said audio transducer to produce a warning sound.

There is a prior art which discloses a warning system for detecting the presence of a child in when a child has been left in an infant seat and a vehicle has been turned off. The apparatus includes an occupant detection mechanism for detecting the presence of an occupant within an infant seat that is located within a vehicle, an ignition detection mechanism for detecting the state of the vehicle's ignition system, a control unit for generating an alarm signal when the occupant detection mechanism detects the presence of an occupant within the infant seat and the ignition detection mechanism detects that the vehicle's ignition system has been turned from an “on” state to an “off” state, and alarm units for generating an alarm in response to the alarm signal. The components of the apparatus can be located within the infant seat, within the vehicle, or combined within the infant seat and the vehicle.

There is already a method and apparatus for detecting the presence of a child on a seat in which information abet the contents of the seat is obtained and a signal is generated based on any contents of the seat. A different signal is generated for different contents of the seat when such contents are present on the seat. The signal is analyzed in order to determine whether the contents of the site include a child seat, and, in a preferred embodiment, a child seat in a rear-facing orientation. Another system within the vehicle may be affected or controlled based on the determination of whether a child seat is present on the seat. The signal is analyzed by pattern recognition techniques that can recognize and thus identify the contents of the seat.

There is a prior art which discloses a child alert alarm for automobiles for detecting the presence of a child locked within a parked automobile during extreme temperatures. The alarm system includes a temperature detecting element, and a child detecting element electrically coupled to an AND gate. The temperature detecting element transmits an extreme temperature signal to the AND gate if the temperature within the automobile exceeds a pre-selected maximum temperature. The child detecting element transmits a child detection signal to the AND gate when it detects a child within the automobile. The AND gate, upon receiving both the child detection signal and the extreme temperature signal, transmits and alarm signal.

For the foregoing reasons, there is a need for a child car seat system that will warn a guardian of a child that a child has been left in the child car seat that is simple to manufacture and does not require the end user to install components into their vehicle.

### SUMMARY OF THE INVENTION

In view of the foregoing disadvantages inherent in the knows types of alarms for automobiles now present in the prior art, the present embodiment of the invention provides an improved infant alarm system for automobiles, and overcomes the above-mentioned disadvantages and drawbacks of the prior art. As such, the general purpose of the present embodiment of the invention, which will be described subsequently in greater detail, is to provide a new and improved infant alarm system for automobiles and method that has all of the advantages of the prior art mentioned heretofore and many novel features that result in an infant alarm system for automobiles. This invention is not anticipated, rendered obvious, suggested, or even implied by the prior art, either alone or in any combination thereof.

It is an objective of the present invention is to provide an alarm system for automobiles.

It is an objective of the present invention is to provide two sensors in the back seat of automobiles for detecting the presence of a child on the back seat.

It is an objective of the present invention is to provide an alarm system that says “Check Back Seat”.

The present embodiment of the invention also includes a side mirror of a car that shows a red light shape of a baby seat.

It is, therefore, an objective of the present embodiment of the invention to provide a new and improved child alarm system for automobiles that has all of the advantages of the prior art alarms for automobiles, and none of the disadvantages.

It is another objective of the present embodiment of the invention to provide a new and improved child alarm system for automobiles that may be easily and efficiently manufactured and marketed.

Numerous objectives, features, and advantages of the present embodiment of the invention will be readily apparent to those of ordinary skill in the art upon a reading of the following detailed description of presently preferred, but nonetheless illustrative, embodiments of the present embodiment of the invention when taken in conjunction with the accompanying drawings. In this respect, before explaining the current embodiment of the embodiment of the invention in detail, it is to be understood that the embodiment of the invention is not limited in its application to the details of construction and to the arrangements of the components set forth in the following description or illustrated in the drawings. The invention is capable of other embodiments, and of being practiced and carried out in various ways. Also, it is to be understood that the phraseology and terminology employed herein are for the purpose of descriptions, and should not be regarded as limiting.

### BRIEF DESCRIPTION OF THE DRAWINGS

FIG. 1. Shows a perspective view of the sensor wires that are connected to the seat belt buckle.

FIG 2. Shows a perspective view of the lights in the shape of car seat flashing on the dash display, and also a perspective view of the side mirror.

FIG. 3. Shows the perspective view of the display signals.

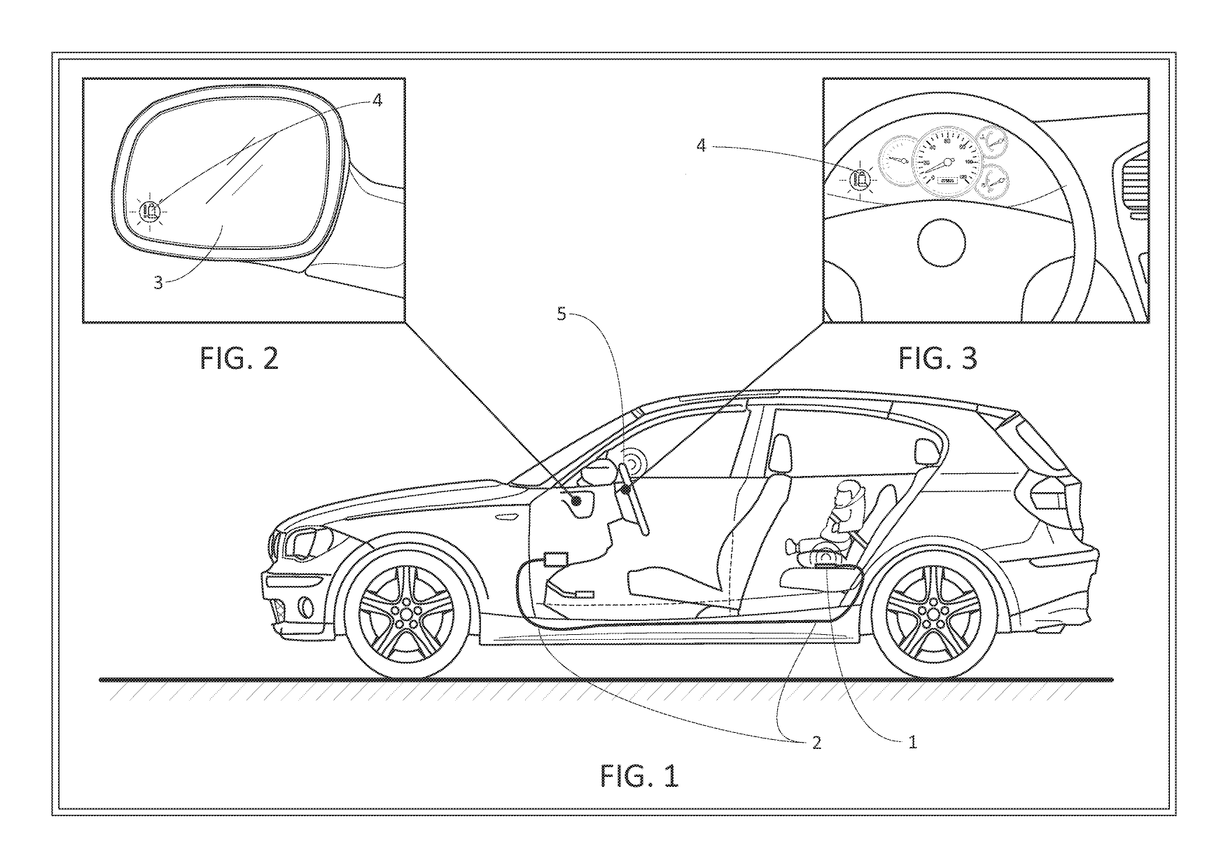

### DETAILED DESCRIPTIONS OF THE INVENTION

As per the preferred embodiment of the present invention, the present invention is a system that will alert distracted parents that their child is still strapped in the back seat. A sensor or sensors 1 installed in the back seat connected to the seat belt locks of the back car seat. The sensors also connected to wires 2 placed under the fabric of the back seat for transmitting the signal received from the sensor. The wires from the sensor run down to the carpet on the driver's side of the vehicle, the fuse box, the dash, the steering column, and the driver's side view mirror 3. This system runs backwards to the adult back seat belt system. When the ignition is turned to the lock position, if the back seatbelt is buckled, the sensor transmits a signal to the dash and side mirror 4., the icon of an infant seat with line marked through it shows on the dash and at the corner of the side view mirror and an alarm 5 starts to ring. In another embodiment, the vehicle automated voice system tells to the parents “Please check your back seat!” and the alert icon lights “Check your back seat”. If the parent attach the child car seat to the base of the back car seat and forget to strap them in the weight sensor registers that the child is in the seat, and the alarm system sends the signal to the dash and side mirror.

When more than five pounds is taken off of the sensor, the system resets itself to zero. The system does not send a false alarm when the base of the seat is left in the vehicle. When users open the door of the car and put their child on the back seat with the ignition in the lock position, the system will run a test. The icon's lights turn on, and the alarm sounds to let the driver know that the system is functioning properly.

The system could be installed in finished vehicles, or ran with the electronic equipment installed in an assembled vehicle. The system is charged by the vehicle battery. The sensor are capable to detect the weight above 2 lbs. and attached to the backside of the back seat wires. Wires run about 12″ to 18″ to the seat belt bucket and under seat fabric. Wires run from the sensors halfway across back seat towards the driver side about 28″, than down 12″ to floor board, Wires are also connected with the side mirror and dash board.

Another embodiment of the invention is a video device to show the caregiver that the child is still seating on the child seat. The caretaker of the child can see on the monitor that the child is seating in the child seat.

Another embodiment of the invention is an audio device to alarm the caretaker of a child is present in the car, if a child still seating in the car on in the car seat the caretaker is able to hear the child voice or sounds creating by the child. The audio device can be installed independently. The car audio system also can be used as the audio device for the alarm system.

Another embodiment of the invention is a speech imitation unit saying by saying “Check the backseat”.

While a preferred embodiment of the sensor installed in the back seat of automobiles has been described in detail, it should be apparent that modifications and variations thereto are possible, all of which fall within the true spirit and scope of the invention. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present embodiment of the invention. For example, any suitable occupant sensor may be used instead of the pressure sensor described. Although an alarm for detecting the presence of an infant in an infant seat when the driver seat is unoccupied have been described, it should be appreciated that the infant alarm system for automobiles herein described is also suitable for warning of unattended cargo.

Therefore, the foregoing is considered as illustrative only of the principles of the embodiment of the invention. Furthermore, since numerous modifications and changes will readily occur to those skilled in the art, it is not desired to limit the embodiment of the invention to the exact construction and operation shown and described. Accordingly, all suitable modifications and equivalents may be resorted to, falling within the scope of the embodiment of the invention.

1. An alarm system for detecting a child left in a car seat in a vehicle, the system comprising:
Light indication means activated by turning on the ignition to the lock position and by bringing a seat belt in buckled up position;
wires;
an alarm unit;
audio means;
visual means;
speech imitation means; and
at least one sensor connected to the seat belt lock by said wires.

2. The alarm system of claim 1, wherein said light indication means show that the child is seating in the car seat.

3. The alarm system of claim 1, wherein said light indication means displayed in a dash display, a steering column and a side view mirror.

4. The alarm system of claim 1, wherein said light indication means having the shape of said car seat.

5. The alarm system of claim 1, wherein said wires are placed under the fabric of the car seat run down to the carpet on the driver's side of the e vehicle.

6. The alarm system of claim 1, wherein said alarm unit provides a warning signal to a caretaker that the child is still in the car.

7. The alarm system of claim 1, wherein said alarm unit warns a child's caretaker through said audio means.

8. The alarm system of claim 1, wherein said alarm unit warns a child's caretaker through said visual means.

9. The alarm system of claim 1, wherein said alarm unit warns a caretaker by said speech imitation means “Check the backseat”.

10. The alarm system of claim 1, wherein said sensor is a weight sensor detecting the presence of child by weight on the back seat of the car.

11. The alarm system of claim 1, wherein said wires connected with the side mirror and the dash board.

12. The alarm system of claim 1, wherein said sensor transmitting signals to said alarm unit after detecting the child's presence in the car seat.

13. The alarm system of claim 1, wherein said sensor resets itself to zero upon changing the weight inside the seat more than five pounds.

14. The alarm system of claim 1, wherein said alarm system is powered by the vehicle battery.

15. The alarm system of claim 1, wherein said visual means area camera and a monitor.

16. The alarm system of claim 1, wherein d audio means is the car audio system.

17. The alarm system of claim 1, wherein said audio means is an independent from the car audio system charged by the vehicle battery.
